(19) United States
(12) Patent Application Publication
(10) Pub. No.: US 2010/0295707 A1
(43) Pub. Date: Nov. 25, 2010

(54) SYSTEM AND METHOD FOR LANE DEPARTURE WARNING

(76) Inventors: Brian Bennie, Sterling Heights, MI (US); Eric L. Reed, Livonia, MI (US); Kristopher Hook, Linden, MI (US)

Correspondence Address: RADER, FISHMAN & GRAUER PLLC;FORD GLOBAL TECHNOLOGIES, INC., 39533 WOODARD AVENUE, SUITE #140, BLOOMFIELD HILLS, MI, 48304, US

(21) Appl. No.: 12/468,491

(22) Filed: May 19, 2009

(51) Int. Cl. G08G 1/123; B60Q 1/00

(52) U.S. Cl. 340/988; 340/439

(57) ABSTRACT

Various methods and systems are disclosed for implementing warnings of various intensity using input from a warning system, such as a lane departure detection system, and a driver assessment system such as a driver impairment detection system.

### BACKGROUND OF THE INVENTION

There are several active safety external sensing technologies that currently exist to improve safety of occupants and drivers of vehicles. Lane departure warning systems are becoming more prevalent as sensing technologies evolve and become more cost effective. Some lane departure systems use a forward looking camera to monitor the position of the vehicle relative to lane markings on the road. If the vehicle begins to drift or depart from the lane, the lane departure system will alert the driver. In the course of normal driving, a driver may implement intentional momentary lane departures, for example when changing lanes without signaling or when swerving to avoid an obstacle. However, a driver may also implement unintentional momentary lane departures, for example when impaired, such as when the driver is inattentive, intoxicated or drowsy, or when distracted by passengers or the radio. This presents an ergonomic and engineering problem when designing a warning system that can adequately get the attention of the driver when a lane departure is unintentional while mitigating the annoyance to the driver when a lane departure is intentional. This may result in the selection of a warning type and level that is not so offensive as to provide the driver with an incentive to disable the warning system, rather than selection of a warning that is intensive enough to relay the sense of urgency to the driver that may be required if the driver is impaired.

More particularly, vehicles may be equipped with various external sensors, such as radar, lasers, and cameras, to detect, track and provide path and obstacle information. The vehicles may also be equipped with internal and external sensors detecting operational data about the vehicle or its components, such as data about the movement of the vehicle and the angle of the wheels. Vehicles may also have a driving environment assessment system, such as a lane departure detection system, to process the data from these external sensors and to assess potential adverse environmental conditions and threats to the vehicle, such as icy roads, unintentional lane departures, unseen vehicles hidden in blind spots, and low lying obstacles. When adverse conditions are detected, they may brought to the attention of the driver so corrective action may be taken. Vehicles may further be equipped with various internal sensors to detect the status or condition of the driver, such as, biometric sensors, systems that monitor the driving behavior of a driver, and systems that monitor the responsiveness of drivers to warnings. These vehicles may have a driver assessment system to process the data from the internal sensors to assess potential driver impairment condition. These driver assessment systems also provide a warning to alert the driver when it appears that he/she is impaired. These systems may provide a visual display to the driver indicative of their level of impairment, such a visual display of their lane tracking driving behavior, or may provide an audible warning if their level of impairment exceeds a preset threshold.

These driver assessment systems and driving environment assessment systems may be independent or may share hardware and software components, such as a microprocessor or a user interface, but they generally operate independently and provide independent warnings to the driver.

The present invention is directed to methods and systems for integrating the operation of a driver assessment system with a driving environment assessment system, such as a lane departure detection system, to implement the warning from the driving environment assessment system at an intensity level determined by the level of driver impairment determined by the driver assessment system.

### BRIEF SUMMARY OF THE INVENTION

The present invention is directed to a system and method for selectively providing an enhanced lane departure or similar adverse condition warning when recognizing that the driver of the vehicle is impaired. The system and method monitor the driver to determine driver status and monitors the environment or status of the vehicle to determine if an adverse condition is occurring and generates a warning of the adverse condition at an intensity level determined by the status of the driver

In one example described below, the system and method monitor the driver to determine a level of driver impairment and monitors the environment and status of the vehicle if a lane departure event is occurring. If it is determined that a lane departure event warrants a driver notification, the notification is provided at an intensity level determined by the level of driver impairment.

### BRIEF DESCRIPTION OF THE DRAWINGS

FIG. 1 is a schematic representation of a vehicle equipped with an integrated lane departure warning system;

FIG. 2 is a representation of a software architecture for an integrated lane departure warning system;

FIG. 3 is a representation of a software flow chart showing steps in an integrated lane departure warning system and method;

FIG. 4 is a representation of alternative software architecture for an integrated lane departure warning system; and

FIG. 5 is a representation of a software flow chart showing alternative steps in an integrated lane departure warning system and method.

### DETAILED DESCRIPTION OF THE INVENTION

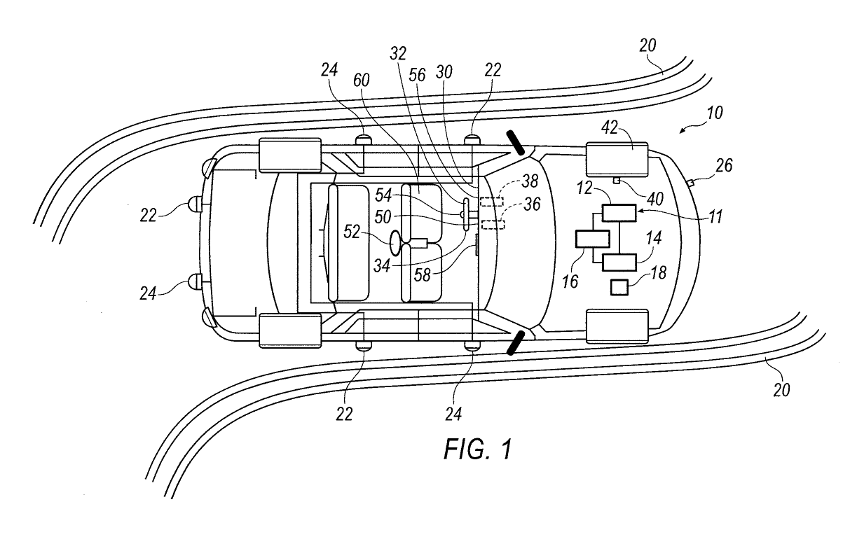

Turning now to the drawings wherein like numbers refer to like structures, and particularly to FIG. 1, a vehicle 10 is equipped with an integrated lane departure detection and warning system 11 or other integrated detection and warning system, having a lane departure detection system 12 or other environmental condition assessment system, a driver assessment system 14, and a driver warning system 16. Vehicle 10 has additional control systems, such as an engine control system 18. It will be appreciated that all vehicle control systems described herein, such as systems 12, 14, 16 and 18, have suitable hardware, memory, and software programs, not shown, to perform their control functions and may share some or all of their hardware or software components.

Vehicle 10 further has sensors providing input to lane departure detection system 12 and driver assessment system 14 to assist in implementing their respective control functions. As used herein, sensors are devices or systems of software and device providing an output usable by a control system to determine a condition of the driver, the vehicle, or the environment around the vehicle.

Sensors to detect a condition of the environment of vehicle 10 may be used to gather data and information about the area surrounding vehicle to provide input to the lane departure detection system 12 for determining where the vehicle is positioned or heading relative to lane markings 20. Environmental condition sensors may similarly be used by the lane departure detection system 12 or other driving environment assessment systems to determine if there are any other vehicles or objects in proximity to the vehicle that may pose a hazard or obstacle to the operation of the vehicle. Environmental condition sensors may include optical sensors 22 capable of detecting the position or orientation of vehicle 10 in a vehicular lane; optical, radar or other sensors 24 capable of detecting the position or motion of other vehicles or obstacles; and thermal sensors 26 capable of detecting temperature conditions conducive to the formation of ice. Other sensors, not shown, may include radio receivers capable of receiving weather and traffic information indicative of environmental conditions around vehicle 10 as well as sensors capable of detecting ice on a roadway, darkness or foggy conditions.

Sensors to detect a condition of the driver may be used to gather data to assist the driver assessment system 14 to determine the level of driver attentiveness and responsiveness or, conversely, the level of driver impairment arising, for example, from fatigue, intoxication, inattention, distraction or medical condition. Driver condition sensors may detect physical signs of driver impairment, such as slow responsiveness to prior conditions or prior warnings, or may detect biological activity, such as heartbeat, breathing rate, perspiration or movement, indicative of driver status or driver impairment. Such sensors may include dashboard mounted optical sensors 30 capable of detecting eye movement, eyelid movement, or head position, or steering wheel mounted sensors 32 capable of measuring heart rate. Still other sensors, not shown, may use the operational inputs of the driver to vehicle 10, such as the timing, frequency and aggressiveness of inputs to the steering wheel 34, the accelerator pedal 36 or the brake pedal 38 or the driver's responsiveness to prior warnings to provide data indicative of driver status.

Sensors to detect a condition of the vehicle may include vehicular operational sensors, such as wheel sensors 40 measuring the angle or rotational speed of a wheel 42. Other sensors, not shown, may include sensors measuring the speed, acceleration, jerk, or yaw of vehicle 10, or the performance of the engine or other components of vehicle 10.

As will be described shortly, the integrated lane departure detection and warning system 11 includes software implemented by the systems 12 and 14 to process data from the sensors to determine the existence of an adverse external condition, such as an undesired lane change, to determine the existence and level of driver impairment, and to provide instructions to warning system 16 to provide an appropriate warning to the driver. Warning system 16 provides an output to a user interface such as a visual, auditory or haptic output, capable of communicating a warning to a driver. Visual output may be provided by a dashboard display or light 50, or an interior cabin light 52. Auditory output many be provided by a horn 54, a speaker 56 or radio 58. Haptic output may be provided, for example, by a system to vibrate driver seat 60 or a system to provide a varied feel to steering wheel 34, providing a physical feedback to the driver.

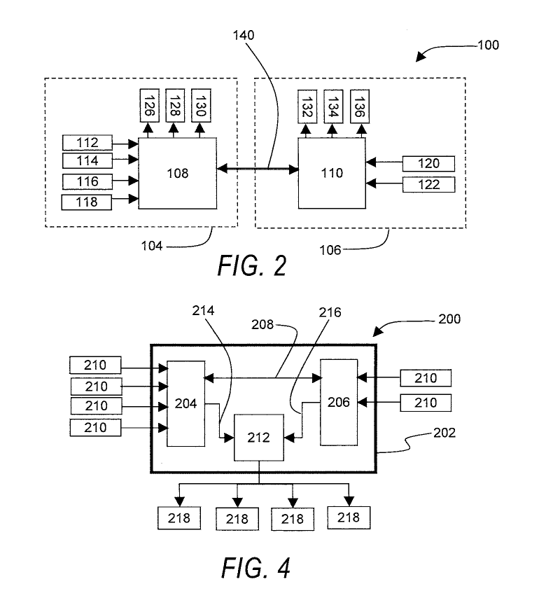

FIG. 2 is a representation of an exemplary system architecture for an integrated lane departure detection and warning system 100 having an electronic control system including a lane departure detection system 104 and a driver assessment system 106 running on independent processors 108 and 110, respectively, and having independent sensors 112, 114, 116, 118, 120 and 122 and user interfaces 126, 128, 130, 132, 134 and 136. Systems 104 and 106 are capable of exchanging data, as shown schematically at 140. Alternatively, lane departure detection system 104 and driver assessment system 106 may share one or more components. For example, systems 104 and 106 may be run on a common microprocessor and operate sequentially, or they may share one or more sensors or user interfaces.

Systems 104 and 106 each receive data from one or more sensors. For example, lane departure detection system 104 may receive driving condition data, such as road ice information, from an environmental condition sensor 112, vehicle control data, such as wheel angle, from a vehicle condition sensor 114, target data, such as lane markings, adjacent vehicles, or obstacles, from a target sensor 116, and vehicular data, such as speed, direction of travel, spin, yaw and gyro information, from a vehicle motion sensor 118. Lane departure detection system 104 processes the sensor data and determines when a lane departure event, such as a current or imminent lane departure, requires a driver warning. Driver assessment system 106 may receive driver responsiveness data, such as accelerator, brake, or steering wheel activity information, for a driver activity sensor 120, and driver biometric data, such as heart rate or eye movement, from a biometric sensor 122 and processes the sensor date to determine the level of driver impairment.

Systems 104 and 106 each provide an output to one or more user interfaces or driver warning devices to provide an alert to a driver. For example, lane departure detection system 104 may provide an output to a steering wheel based haptic system 126, a dashboard warning light 128, and a piezo speaker 130 and driver assessment system 106 may provide and output to a seat based haptic system 132, an interior warning light 134, and a radio 136.

Systems 104 and 106 independently evaluate driving environment and driver status and direct their respective user interfaces to provide a driver alert. However, they exchange information, as shown at 140, to improve their respective operation. For example, lane departure detection system 104 may use driver impairment information from driver assessment system 106 to determine the intensity of warning to provide for a lane departure event. Driver assessment system 106 may use driver behavior data collected by lane departure detection system 104 in assessing driver status. Lane departure detection system 104 may use a user interface associated with driver assessment system 106 to selectively increase the intensity of a lane departure event.

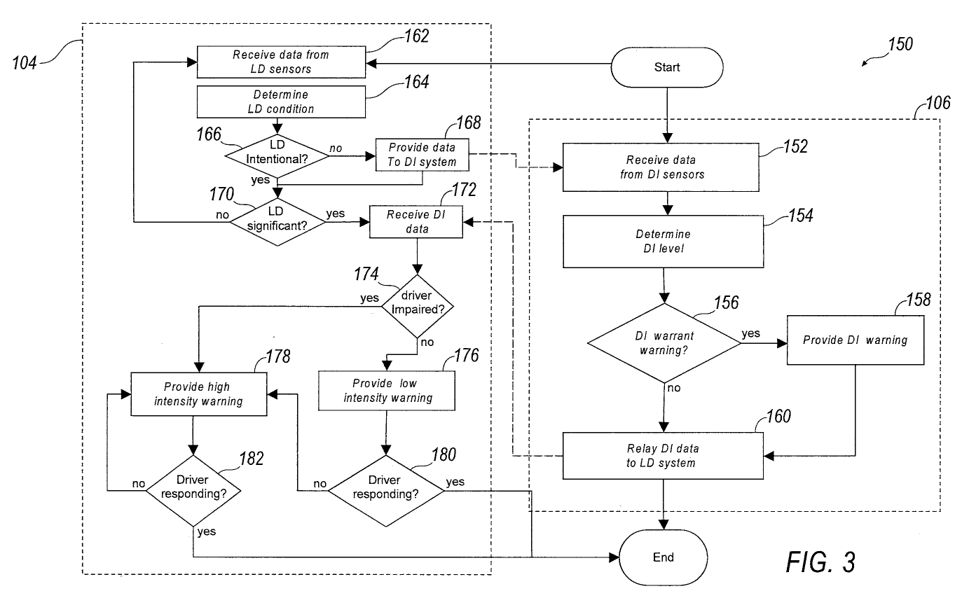

FIG. 3 is a flow chart representing exemplary software process 150 for integrated lane departure detection and warning system 100, wherein software associated with lane departure detection system 104 and with driver assessment system 106 are both illustrated. While process 150 is illustrated as two simultaneous subprocesses corresponding to systems 104 and 106, it will be appreciated that the order of steps may be varied for sequential implementation on a single processor.

Process 150 starts for the driver assessment system 106 with receiving sensor data at step 152 and determining the level of driver impairment at step 154. At step 156, system 106 determines if an impairment warning is needed. If needed, then, at step 158, system 106 instructs the driver warning system to provide a warning of driver impairment. It should be noted that this warning may be independent of any warning relating to an adverse condition. Next, in step 160, whether or not an impairment warning is provided, driver assessment system 106 relays driver impairment data to lane departure detection system 104. Next, the process for system 106 ends or it returns to step 152.

Meanwhile, process 150 starts for lane departure detection system 104 at step 162 with receiving sensor data and continues with determining, at step 164, if a lane departure event is detected and, at step 166, if the lane departure event is intentional. If the lane departure event is unintentional, lane departure data is provided in step 168 to driver assessment system 106 where it is may be used in step 154, described above, in determining the level of driver impairment. Next, in step 170, whether or not lane departure data is provided by system 104 to system 106, lane departure detection system determines if the lane departure event is significant enough to warrant a lane departure warning. If no significant lane departure event warranting a warning is detected, system 104 returns to step 162. If a significant lane departure event is detected in step 170, then in step 172, system 104 receives from system 106 data on the level of driver impairment and next, in step 174, determines if the level of driver impairment warrants a low intensity driver warning, provided in step 176, or a high intensity driver warning, provided in step 178. If a low intensity warning is provided in step 176, system 106 determines in step 180 if the driver is responding to the warning. If the driver responds to the low intensity warning or the lane departure condition is terminated, the process for system 104 ends or it returns to step 162. If the driver does not respond to the low intensity warning provided in step 176, step 180 directs operation to step 178 and a high intensity warning is provided. If a high intensity warning is provided in step 178, system 106 determines in step 182 if the driver is responding to the warning or if the lane departure condition has terminated. If the driver responds to the high intensity warning or the lane departure condition is terminated, the process for system 104 ends or it returns to step 162. If the driver does not respond to the low intensity warning provided in step 176, step 180 continues to direct operation to step 178 and a high intensity warning is provided. Alternatively, other corrective action could be taken in step 180, such as providing a further incremental change in the intensity of the warning.

It should be noted that intensity may be increased in step 178 relative to step 176 by providing an increase in the power level of the warning, such as by increasing the volume or frequency of a an auditory warning or increasing the amount of illumination of a visual warning. Alternatively or additionally, the frequency of an auditory or visual warning may be varied to a frequency that provides a more intense experience to the driver. Intensity may also be increased by introducing a pattern of level or frequency changes that is likely to get more attention from an inattentive driver, such as a periodically increasing the volume, duration or frequency of an auditory warning or flashing a visual warning. Alternatively, intensity may be increased by combining two independent warning devices, such as a adding an auditory warning or haptic warning to a visual warning when a higher intensity is desired. Alternatively, the intensity may be increased by muting the radio so that the warning is more noticeable to the driver.

FIG. 4 is a representation of another exemplary system architecture for an integrated lane departure detection and warning system 200 having an electronic control system 202 including a lane departure detection system 204 and a driver assessment system 206 running on a common microprocessor or otherwise capable of exchanging data as shown schematically at 208 and receiving input from a plurality of sensors 210.

Integrated lane departure detection and warning system 200 further includes a shared driver warning system 212 implemented on the same microprocessor as systems 204 and 206 or otherwise capable of receiving instructions from systems 202 and 204, as shown at 214 and 216, respectively. Driver warning system 212 controls one or more user interfaces or driver warning devices 218. Driver warning system 212 may be used independently by systems 204 and 206 and by other control systems in the vehicle to provide appropriate driver warnings or notifications. However, the integrated lane departure detection and warning system 200 described herein integrates the operation of systems 204 and 206 by setting the intensity of a lane departure warning requested by system 204 in response to the level of driver impairment detected by system 206.

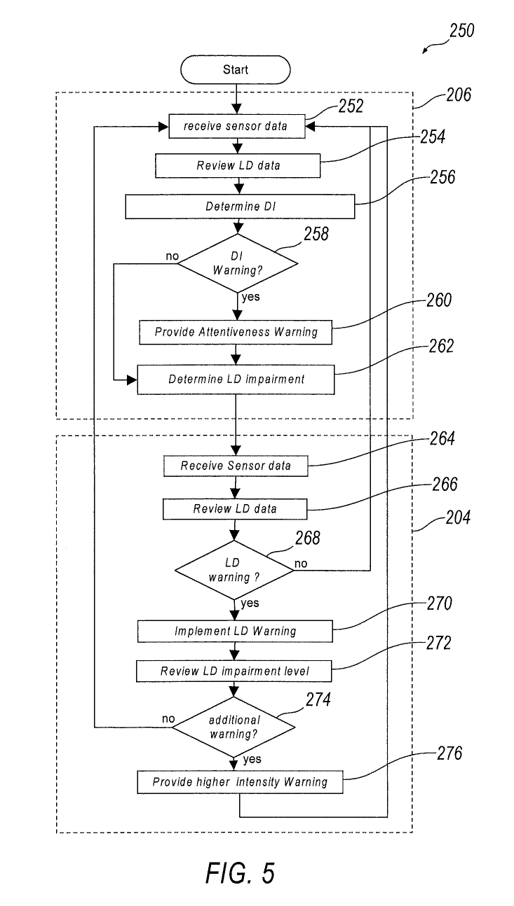

FIG. 5 is a flow chart representing exemplary software process 250 for integrated lane departure detection and warning system 200, wherein software associated with lane departure detection system 204 and with driver assessment system 206 are both illustrated. While process 250 is illustrated as two sequential subprocesses corresponding to systems 204 and 206, it will be appreciated that the order of steps may be varied for simultaneous implementation on separate processors.

Process 250 starts with implementing driver assessment system 206 by receiving sensor data at step 252. At step 254, driver assessment system 206 reviews lane departure data, if any, that may have been stored by lane departure detection system 204 in a previous cycle of process 250 from step 266, described below. Driver assessment system next assesses the level of driver impairment at step 256 and next, at step 258, determines if an impairment warning is warranted. If an impairment warning is required, it may be implemented at step 260. Whether or not an impairment warning is provided at step 260, system 206 next determines at step 262 the a level of lane departure related impairment which data may be used as an input to the lane departure detection system 204 in step 272 described below. Lane departure impairment may be the level of impairment determined from sensor data or may arise from a refined assessment of lane departure data reviewed in step 254 to better predict the impairment of the driver as it relates to lane departure events or lane departure responsiveness. Process 250 next proceeds with implementing lane departure detection system 204 by receiving sensor data at step 264. Next, at step 266, lane departure detection system 204 evaluates lane departure data and compiles data that may be used by driver assessment system in step 254 in assessing driver impairment. Next, at step 268, lane departure detection system 204 determines if a lane departure warning is required. If no lane departure warning is required, process 250 returns to implementing driver assessment system 206 at step 252. If a lane departure warning is required, then at step 270, system 204 implements a lane departure warning. Next, at step 272, lane departure detection system 204 reviews any lane departure impairment data that may have been stored by driver assessment system at step 254, described above. Next, at step 274, lane departure detection system 204 determines if an enhanced or additional warning is required, which may be implemented at step 276. Whether or not an enhanced warning is provided at step 276, process 250 next returns to implementing driver assessment system 206 at step 252.

The warnings provided in steps 260, 270 and 276 may be provided for a predetermined period of time and then cease unless reimplemented by process 250. Alternatively, process 250 may implement alternative steps, not shown, after a warning is implemented in steps 270 or 276 to determine if the warning should be continued or modified and return to step 252 only after a warning is no longer required, Furthermore, it will be appreciated that while only two levels of warning intensity have been described, processes 150 and 250 may provide any number of levels of warning intensity in response to the level or type of driver impairment detected.

Several systems and methods for activating a driver warning when it is determined that an undesirable lane departure has occurred have been discussed, wherein the intensity of the warning is determined by an evaluation of driver impairment. The words used herein are words of description and not words of limitation. Those skilled in the art will recognize that various modifications may be made to the systems and methods disclosed without departing from the scope and spirit of the invention as set forth in the appended claims.

What is claimed as new and desired to be protected by Letters Patent of the United States is:

1. An integrated detection and warning system for a host vehicle, said warning system comprising:
a sensor system adapted for sensing and providing sensor data indicative of driver status and vehicular environmental conditions;
a first control system operatively connected the sensor system to receive sensor data therefrom, the first control system being adapted to evaluate the sensor data from and to selectively provide driver assessment data;
a second control system operatively connected to both the sensor system and to the first control system to receive data therefrom, the second control system being adapted to evaluate the sensor data to selectively determine that an adverse condition warning is required and to evaluate the driver assessment data to selectively alternatively provide a low intensity warning control output and a high intensity warning control output; and
a driver warning system operatively connected to the second control system to receive the adverse condition warning control output therefrom, the driver warning system being adapted to selectively alternatively provide a low intensity warning in response to a low intensity warning control output and a high intensity warning in response to a high intensity warning control output.

2. The integrated detection and warning system of claim 1, wherein the sensor system further comprises at least one of a biometric sensor, a sensor monitoring driving behavior, and a sensor monitoring driver responsiveness to warnings.

3. The integrated detection and warning system of claim 1, wherein the sensor data indicative of vehicular driving conditions comprises at least one of a location of driving lanes, location of barriers, vehicle direction of motion, vehicle speed, vehicle acceleration, vehicle pitch, vehicle yaw, wheel angle, wheel speed, speed limit, traffic conditions and road conditions.

4. The integrated detection and warning system of claim 1, wherein the sensor data indicative of driver status comprises at least one of impairment, reaction time, driving behavior, behavior specific to the hazard, lane departure, alertness.

5. The integrated detection and warning system of claim 1, wherein the driver warning system comprises a plurality of user interfaces for selectively providing a warning to a driver.

6. The integrated detection and warning system of claim 1, wherein the high intensity warning differs from the low intensity warning by at least one of power level of a warning, frequency of a warning, duration of warning, type of user interface used to provide a warning, variation in a warning pattern, variation in a warning frequency, and variation in a warning duration.

7. The integrated detection and warning system of claim 1, wherein the first control system is further adapted to evaluate the sensor data and to selectively provide a driver status warning output, the warning system is further operatively connected to the driver status warning output therefrom, and the warning system is adapted to provide a driver status warning in response to the driver status warning output.

8. The system of claim 1, wherein the driver warning system comprises at least one of a warning light, a cabin light, an information display, a radio, a speaker, a haptic system.

9. The system of claim 1 wherein the low intensity warning comprises at least one of an audible warning and a visual warning and the high intensity warning comprises the low intensity warning combined with a haptic warning.

10. The system of claim 1 wherein the adverse condition detection system comprises a lane departure detection system, the driver assessment system comprises a driver impairment detection system.

11. An integrated lane departure detection and warning system for warning a driver of a host vehicle of an adverse lane departure event, said warning system comprising:
a driver impairment monitoring system comprising:
a first sensor adapted for sensing and providing data indicative of the impairment level of a driver:
a first control system operatively connected to the first sensor for receiving data therefrom, the first control system being adapted to evaluate data from the first sensor and to selectively provide a driver impairment output: and
a first driver warning system operatively connected to the first control system for receiving driver impairment output therefrom, the first driver warning system comprising at least a first user interface component adapted to selectively provide a driver impairment warning in response to the driver impairment output: and
a lane departure monitoring system comprising:
a second sensor adapted for sensing and providing data indicative of lane departure:
a second control system operatively connected to both the second sensor and to the first control system for receiving data therefrom, the controller being adapted to evaluate data from the second sensor to selectively determine that a lane departure warning is required, to evaluate the driver impairment output to determine a selected level of intensity, and to provide a lane departure warning control output indicating the selected level of intensity: and
a second driver warning system operatively connected to the second control system for receiving the lane departure warning control output therefrom, the second driver warning system being adapted to selectively implement a lane departure warning at the selected level of intensity in response to the lane departure warning control output.

12. The integrated lane departure detection and warning system of claim 11 wherein the second control system further provides the first control system with lane departure data, the first control system being adapted to evaluate the lane departure data together with data from the first sensor to selectively provide the driver impairment output.

13. A method for warning a driver of a vehicle of an adverse condition, the method comprising:
determining whether an adverse condition exists;
determining the condition of the driver;
selecting a warning intensity based on the condition of the driver; and
delivering to the driver an adverse condition warning of the selected intensity.

14. The method of claim 13, wherein the determining whether an adverse condition exists further comprises determining a lane departure event.

15. The method of claim 14, wherein the determining the condition of the driver comprises determining the level of driver impairment.

16. The method of claim 15, wherein the determining the level of driver impairment further comprises:
monitoring a history of lane departure events; and
determining the level of driver impairment at least partially from the recent history of lane departure.

17. The method of claim 15, wherein the determining the level of driver impairment further comprises monitoring at least one of the recent history of driver operational behavior and biometric driver information.

18. The method of claim 12, wherein the selecting a warning intensity comprises at least one of selecting a power level of a warning, selecting a pattern of varying a warning, selecting a type of a warning, and selecting a duration of a warning.

19. The method of claim 12, wherein the adverse condition warning in the form of at least one of an acoustical warning, a light, a display, and a haptic warning.

20. The method of claim 12, further comprising determining the level of driver responsiveness to an adverse condition warning and adjusting the intensity of the adverse condition warning in response to the level of driver responsiveness.
